(19) United States
(12) Patent Application Publication
(10) Pub. No.: US 2024/0220931 A1
(43) Pub. Date: Jul. 4, 2024

(54) METHOD AND VALUE CONSTRAINT MANAGEMENT SERVER FOR MANAGING VALUE CONSTRAINTS ASSOCIATED WITH PROPERTIES OF ENTITIES

(71) Applicant: Rakuten Mobile, Inc., Tokyo (JP)

(72) Inventors: Pawan SHRIWAS, Indore (IN); Apurva TRIPATHI, Indore (IN)

(21) Appl. No.: 17/998,157

(22) PCT Filed: Aug. 29, 2022
(86) PCT No.: PCT/US2022/041806

§ 371 Date: Nov. 8, 2022

(30) Foreign Application Priority Data
Jul. 6, 2022 (IN) 202241038767

(51) Int. Cl. G06Q 10/105

(52) U.S. Cl. CPC G06Q 10/105

(57) ABSTRACT

A method for managing value constraints associated with properties of entities in a graph database includes receiving, by a value constraint management server, a request for creation of entity and generating, by the value constraint management server, an entity configuration file based on the values associated with properties of the entity to be created. The request includes values associated with the properties of the entity and the entity configuration file includes value constraints to be applied to the entity. The method also includes retrieving, by the value constraint management server, metadata corresponding to value constraints from a constraint database based on the entity configuration file and creating, by the value constraint management server, the entity based on the metadata corresponding to the value constraints and the values associated with the properties of the entity to be created.

### FIELD OF INVENTION

The present invention relates to entity management and more specifically related to a method and value constraint management server for managing value constraints associated with properties of entities.

### BACKGROUND

In general, inventories of large organizations are maintained using graph databases where various entities are created to represent various departments or elements of the large organizations. Each entity created within the graph database includes properties such as a label defined between entities, characteristics of entities, etc. which may be defined on a global graph level. Type value for a property of the entity is defined by a user at a time of creation of an entity. However, there is no a check performed to determine if there are any constraints to the type value for the property of the entity. As a result, an admin or a supervisor will have to specifically look into the type value for the property of the various entities which is a very consuming and cumbersome process. Also, when handling the inventories of the large organizations, then multiple human resources may have to be deployed to check the fulfillment of the type value for the property of the various entities which may increase cost of the human resources in the large organizations. Also, the same human resource could be used to perform other tasks. Thus, it is desired to address the aforementioned disadvantages or other shortcomings or at least provide a useful alternative.

### OBJECT OF INVENTION

The principal object of the embodiments herein is to provide a method and value constraint management server for managing value constraints associated with properties of entities which controls allowed values of the properties of the entities. The proposed method operated at a validation layer of a graph database and hence if the values constraints are not satisfied then the entities is not created. Therefore, the proposed method helps in saving memory as well as processing capacity of the value constraint management server without creating the entities when the value constraints are not satisfied.

### SUMMARY

Accordingly, the embodiment herein is to provide a method for managing value constraints associated with properties of entities in a graph database. The method includes receiving, by a value constraint management server, a request for creation of entity and generating, by the value constraint management server, an entity configuration file based on the values associated with the plurality of properties of the entity to be created. The entity configuration file includes value constraint from a plurality of value constraints to be applied to the entity and the request includes values associated with a plurality of properties of the entity to be created. Further, the method also includes retrieving, by the value constraint management server, metadata corresponding to value constraints from a constraint database based on the entity configuration file and creating, by the value constraint management server, the entity based on the metadata corresponding to the value constraints and the values associated with the plurality of properties of the entity to be created; and storing, by the value constraint management server, the entity in the graph database.

In an embodiment, creating, by the value constraint management server, the entity based on the metadata corresponding to the value constraints and the information of the entity includes determining, by the value constraint management server, whether the values associated with the plurality of properties of the entity to be created matches the value constraints in the entity configuration file. Further, the method includes performing, by the value constraint management server, creating the entity based on the metadata corresponding to the value constraints and the information of the entity, in response to determining that the values associated with the plurality of properties of the entity to be created matches the value constraints in the entity configuration file, and displaying an error message indicating that the entity cannot be created based on the received request, in response to determining that the values associated with the plurality of properties of the entity to be created does not match the value constraints in the entity configuration file.

In an embodiment, the value constraint management server operates in a validation layer of the graph database.

In an embodiment, the at least one value constraint comprises at least one of: at least one of enumerations of a property of the at least one entity, a range of a property of the at least one entity, a length of a property of the at least one entity and a pattern of a property of the at least one entity.

In an embodiment, the method further includes receiving, by the value constraint management server, a request to update a portion of a value associated with property of the plurality of properties of the entity and determining, by the value constraint management server, whether a value type for the property is available in the graph database. Further, the method also includes performing, by the value constraint management server, update of only enumeration of the at least one property, in response to determining that the value type for the property is available in the graph database, and update the enumerations of the property of the entity, the range of the property of the entity, the length of the property of the entity and the pattern of the property of the entity, in response to determining that the value type for the property is not available in the graph database.

Accordingly, the embodiments herein provide a value constraint management server for managing value constraints associated with properties of entities in a graph database. The value constraint management server includes a memory, a processor, a communicator and a value management controller. The value management controller is configured to receive a request for creation of entity and generate an entity configuration file based on the values associated with the plurality of properties of the entity to be created. The request includes values associated with a plurality of properties of the entity to be created and the entity configuration file includes value constraint from a plurality of value constraints to be applied to the entity. Further, the value management controller is configured to retrieve metadata corresponding to value constraints from a constraint database based on the entity configuration file; create the entity based on the metadata corresponding to the value constraints and the values associated with the plurality of properties of the entity to be created; and store the entity in the graph database.

Accordingly, the embodiments herein provide a computer program product (CPP) for managing value constraints associated with properties of entities in a graph database. The CPP includes a computer executable program code recorded on a computer readable non-transitory storage medium. The said computer executable program code when executed causing the actions including: receiving a request for creation of entity and generating an entity configuration file based on the values associated with the plurality of properties of the entity to be created. The request includes values associated with a plurality of properties of the entity to be created and the entity configuration file includes value constraint from a plurality of value constraints to be applied to the entity. Further, the CPP includes retrieving metadata corresponding to value constraints from a constraint database based on the entity configuration file and creating the entity based on the metadata corresponding to the value constraints and the values associated with the plurality of properties of the entity to be created; and storing the entity in the graph database.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 is a block diagram of a value constraint management server for managing value constraints associated with entities in a graph database, according to an embodiment as disclosed herein;

FIG. 2 is a flow chart illustrating a method for managing value constraints associated with entities in a graph database, according to an embodiment as disclosed herein;

FIG. 3 is an example illustrating addition of value constraints as a new scheme element, according to an embodiment as disclosed herein;

FIG. 4 illustrates a step-by-step process for application of type validation during validation phase of entity creation, according to an embodiment as disclosed herein; and

FIG. 5 is an example illustrating response for a GET application program interface (API), according to an embodiment as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As it is traditional in the field, the embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiment herein is to provide a method for managing value constraints associated with properties of entities in a graph database. The method includes receiving, by a value constraint management server, a request for creation of entity and generating, by the value constraint management server, an entity configuration file based on the values associated with the plurality of properties of the entity to be created. The entity configuration file includes value constraint from a plurality of value constraints to be applied to the entity and the request includes values associated with a plurality of properties of the entity to be created. Further, the method also includes retrieving, by the value constraint management server, metadata corresponding to value constraints from a constraint database based on the entity configuration file and creating, by the value constraint management server, the entity based on the metadata corresponding to the value constraints and the values associated with the plurality of properties of the entity to be created; and storing, by the value constraint management server, the entity in the graph database.

Accordingly, the embodiments herein provide a value constraint management server for managing value constraints associated with properties of entities in a graph database. The value constraint management server includes a memory, a processor, a communicator and a value management controller. The value management controller is configured to receive a request for creation of entity and generate an entity configuration file based on the values associated with the plurality of properties of the entity to be created. The request includes values associated with a plurality of properties of the entity to be created and the entity configuration file includes value constraint from a plurality of value constraints to be applied to the entity. Further, the value management controller is configured to retrieve metadata corresponding to value constraints from a constraint database based on the entity configuration file; create the entity based on the metadata corresponding to the value constraints and the values associated with the plurality of properties of the entity to be created; and store the entity in the graph database.

Accordingly, the embodiments herein provide a computer program product (CPP) for managing value constraints associated with properties of entities in a graph database. The CPP includes a computer executable program code recorded on a computer readable non-transitory storage medium. The said computer executable program code when executed causing the actions including: receiving a request for creation of entity and generating an entity configuration file based on the values associated with the plurality of properties of the entity to be created. The request includes values associated with a plurality of properties of the entity to be created and the entity configuration file includes value constraint from a plurality of value constraints to be applied to the entity. Further, the CPP includes retrieving metadata corresponding to value constraints from a constraint database based on the entity configuration file and creating the entity based on the metadata corresponding to the value constraints and the values associated with the plurality of properties of the entity to be created; and storing the entity in the graph database.

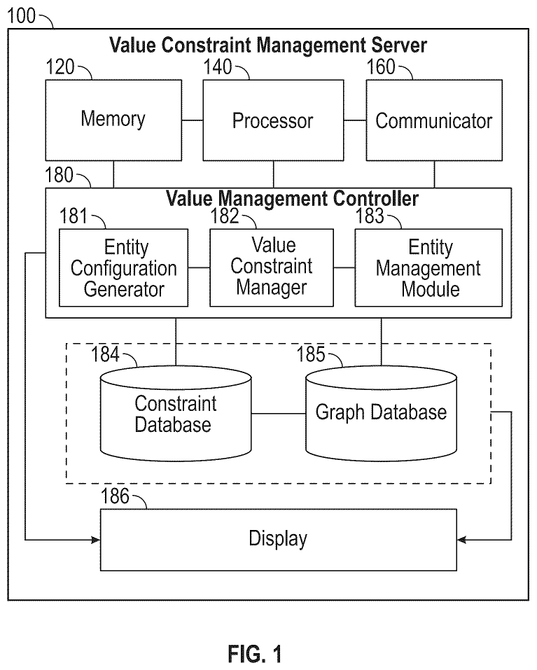

Referring now to the drawings and more particularly to FIGS. 1 through 5, where similar reference characters denote corresponding features consistently throughout the figures, there are shown preferred embodiments.

FIG. 1 is a block diagram of a value constraint management server (100) for managing relationship constraints associated with entities in a graph database (184), according to an embodiment as disclosed herein.

In an embodiment, the value constraint management server (100) includes a memory (120), a processor (140), a communicator (160) and a value management controller (180). The value constraint management server (100) operates in a validation layer of the graph database (185).

The ‘memory (120) is configured to store instructions to be executed by the processor (140). The memory (120) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (120) may, in some examples, be considered a non-transitory storage medium. The term “non-transitory” may indicate that the storage medium is not embodied in a carrier wave or a propagated signal. However, the term “non-transitory” should not be interpreted that the memory (120) is non-movable. In some examples, the memory (120) can be configured to store larger amounts of information. In certain examples, a non-transitory storage medium may store data that can, over time, change (e.g., in Random Access Memory (RAM) or cache).

The processor (140) communicates with the memory (120), the communicator (160), and the value management controller (180). The processor (140) is configured to execute instructions stored in the memory (120) and to perform various processes. The processor may include one or a plurality of processors, may be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (160) includes an electronic circuit specific to a standard that enables wired or wireless communication. The communicator (160) is configured to communicate internally between internal hardware components of the value constraint management server (100) and with external devices via one or more networks.

In an embodiment, the value management controller (180) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductors. The value management controller (180) includes an entity configuration generator (181), a value constraint manager (182), an entity management module (183), a constraint database (184), a graph database (185) and a display (186).

In an embodiment, the entity configuration generator (181) is configured to receive a request for creation of an entity in the graph database (185) and generate an entity configuration file based on the values associated with multiple properties of the entity which needs to be created. The request includes values associated with multiple properties of the entity to be created and the entity configuration file which is generated will include value constraints out of multiple value constraints, to be applied to the entity while creation of the entity in the graph database (185). The value constraint includes for example but is not limited to enumerations of a property of the entity, a range of a property of the entity, a length of a property of the entity and a pattern of a property of the entity. The enumerations of the property of the entity includes values of the property of the entity must be one of a pre-defined set of fixed values, the range of the property of the entity includes numeric values of the property of the entity must be within a pre-defined range, the length of the property of the entity must be a pre-defined set of fixed values and pattern of the property of the entity includes string values must fit some syntactic criteria, expressed as a regular expression.

The entity configuration generator (181) is also configured to receive a request to update a portion of a value associated with the property of the entity.

In an embodiment, the value constraint manager (182) is configured to retrieve metadata corresponding to the value constraints from the constraint database (184) based on the entity configuration file and determine whether the values associated with the multiple properties of the entity to be created matches the value constraints in the entity configuration file. The value constraint manager (182) is also configured to determine whether a value type for the property is available in the graph database (185) on receiving the request to update the portion of the value associated with the property of the entity.

In an embodiment, the entity management module (183) is configured to create the entity based on the metadata corresponding to the value constraints and the information of the entity, on determining that the values associated with the multiple properties of the entity to be created matches the value constraints in the entity configuration file by the value constraint manager (182). The entity management module (183) is configured to display an error message indicating that the entity cannot be created based on the received request, on determining that the values associated with the multiple properties of the entity to be created does not match the value constraints in the entity configuration file by the value constraint manager (182).

In an embodiment, the entity management module (183) is configured to update only the enumeration of the property of the entity, when the value constraint manager (182) determines that the value type for the property is available in the graph database (185). The entity management module (183) is configured to update the enumerations of the property of the entity, the range of the property of the entity, the length of the property of the entity and the pattern of the property of the entity, when the value constraint manager (182) determines that the value type for the property is not available in the graph database (185).

In an embodiment, the constraint database (184) is configured to store actual configuration of each of the multiple value constraints. The actual configuration of the value constraints are not provided to the value constraint manager (182). Only the metadata corresponding to the relationship constraints are shared with the value constraint manager (182) from the constraint database (185) based on the entity configuration file.

In an embodiment, the graph database (185) is configured to store the entities as and when the entities are created. In an embodiment, the constraint database (185) and the graph database (185) may be separate elements located within the value constraint management server (100). In another embodiment, the constraint database (185) and the graph database (185) may be a single element located within the value constraint management server (100) (indicated by dotted lines in the FIG. 1). The constraint(s) database (185) and the graph database (185) may be located within the memory (120) or out of the memory (120) of the value constraint management server (100).

At least one of the plurality of modules/components of the value management controller (180) may be implemented through an AI model. A function associated with the AI model may be performed through memory (120) and the processor (140). The one or a plurality of processors controls the processing of the input data in accordance with a predefined operating rule or the AI model stored in the non-volatile memory and the volatile memory. The predefined operating rule or artificial intelligence model is provided through training or learning.

In an embodiment, the display (186) is configured to display a user interface (UI) which allows the browsing and modification of global types, including enumerations, ranges, length, and patterns. Further, the UI is to be available to browse and update shared type definitions, in particular, the enums. The display (186) can receive inputs, and is made of one of liquid crystal display (LCD), light emitting diode (LED), organic light-emitting diode (OLED), etc. The user inputs may be provided as for example but not limited to touch, swipe, drag, gesture, voice command, etc. The types can only be updated in a backward-compatible way as:
1. enumeration: values can be added and removed from the UI
2. range values can only broaden a range
3. length values can only broaden a length spec
4. pattern cannot be replaced, as there is no automated method to determine compatibility.

Further, the UI provides a semi-automated migration before enabling a constraint, run a check to determine whether existing data complies with the type, and if satisfied, then attach the type to the characteristic can most easily be applied to indexable enums, since a group query can be performed efficiently for other data types an exhaustive search needs to be performed.

Although the FIG. 1 shows various hardware components of the value constraint management server (100), but it is to be understood that other embodiments are not limited thereon. In other embodiments, the value constraint management server (100) may include less or a greater number of components. Further, the labels or names of the components are used only for illustrative purpose and does not limit the scope of the invention. One or more components can be combined to perform same or substantially similar function to manage the value constraints associated with the entities in the graph database (185).

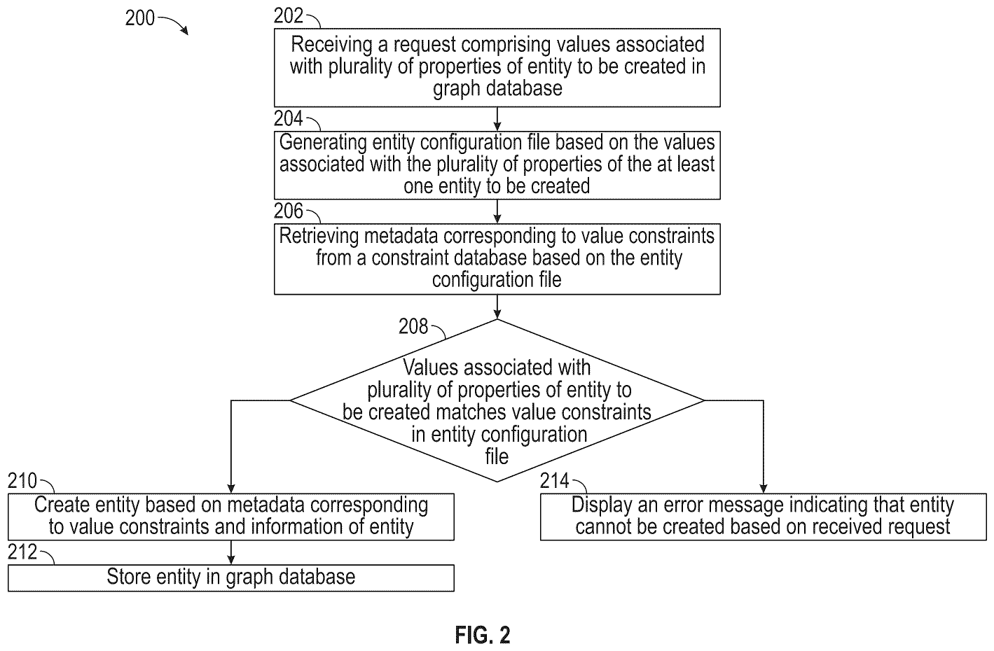

FIG. 2 is a flow chart (200) illustrating a method for managing the value constraints associated with the entities in the graph database (185), according to an embodiment as disclosed herein.

Referring to the FIG. 2, at step 202, the method includes the value constraint management server (100) receiving the request including the values associated with multiple properties of the entity to be created in the graph database (185). For example, in the value constraint management server (100) as illustrated in the FIG. 1, the value management controller (180) is configured to receive the request including the values associated with multiple properties of the entity to be created in the graph database (185).

At step 204, the method includes the value constraint management server (100) generating the entity configuration file based on the values associated with the multiple properties of the entity to be created. For example, in the value constraint management server (100) as illustrated in the FIG. 1, the value management controller (180) is configured to generate the entity configuration file based on the values associated with the multiple properties of the entity to be created.

At step 206, the method includes the value constraint management server (100) retrieving the metadata corresponding to the value constraints from the constraint database (184) based on the entity configuration file. For example, in the value constraint management server (100) as illustrated in the FIG. 1, the value management controller (180) is configured to retrieve the metadata corresponding to the value constraints from the constraint database (184) based on the entity configuration file.

At step 208, the method includes the value constraint management server (100) determining whether the values associated with the multiple properties of the entity to be created matches the value constraints in the entity configuration file. For example, in the value constraint management server (100) as illustrated in the FIG. 1, the value management controller (180) is configured to determine whether the values associated with the multiple properties of the entity to be created matches the value constraints in the entity configuration file.

At step 210, the method includes the value constraint management server (100) creating the entity based on the metadata corresponding to the value constraints and the values associated with the multiple properties of the entity to be created and at step 212, storing the entity in the graph database (185), in response to determining that the values associated with the multiple properties of the entity to be created matches the value constraints in the entity configuration file. For example, in the value constraint management server (100) as illustrated in the FIG. 1, the value management controller (180) is configured to create the entity based on the metadata corresponding to the value constraints and the values associated with the multiple properties of the entity to be created and store the entity in the graph database (185), in response to determining that the values associated with the multiple properties of the entity to be created matches the value constraints in the entity configuration file.

At step 214, the method includes the value constraint management server (100) displaying the error message indicating that entity cannot be created based on the received request, in response to determining that the values associated with the multiple properties of the entity to be created does not match the value constraints in the entity configuration file. For example, in the value constraint management server (100) as illustrated in the FIG. 1, the value management controller (180) is configured to display the error message indicating that entity cannot be created based on the received request, in response to determining that the values associated with the multiple properties of the entity to be created does not match the value constraints in the entity configuration file.

The various actions, acts, blocks, steps, or the like in the flow diagram (200) may be performed in the order presented, in a different order or simultaneously. Further, in some embodiments, some of the actions, acts, blocks, steps, or the like may be omitted, added, modified, skipped, or the like without departing from the scope of the invention.

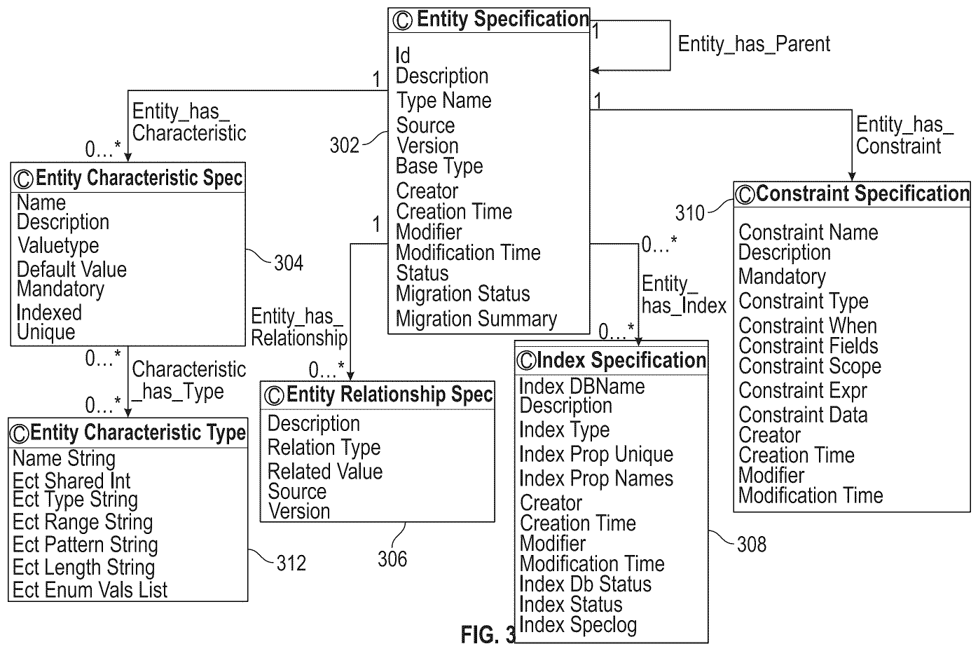

FIG. 3 is an example illustrating addition of value constraints as a new scheme element, according to an embodiment as disclosed herein.

Referring to the FIG. 3, the proposed type based value constraints use basic extensions to simple types to control the allowed values of properties of the entities to be created, i.e., even before the entity is created in the graph database (186). At step 302, the metadata (EntitySpecifications) in the inventory is to be extended so that the basic types (string, int32, etc) can have additional qualification to specify the additional controls. These extended types can be installed as available types alongside the standard types, by any specification. Further, various entries are provided from step 304 to step 310 for the properties which are represented at vertices in the graph database (185).

At step 304, the EntityCharacteristicSpec is provided which includes various characteristics such as name of the property, description of the property, valueType, defaultValue, mandatory characteristics, indexed and unique characteristics. Similarly, at step 306, metadata provides description of the relationship between entities, relationType, relatedValue, source and version details and at step 308, the metadata IndexSpecification includes indexDBName, description, indexType, indexPropUnique, indexPropNames, creator, creationTime, modifier, modificationTime, indexDBStatus, indexStatus and indexSpecLog. At step 310, the metadata ConstraintSpecification includes constraintName, description, mandatory, constraintType, constraintWhen, constraintFields, constraintScope, constraintExpr, constraintData, creator, creationTime, modifier and modificationTime.

At step 312, the characteristics include type. The type specifications can be loaded via extensions to the CI modeling YANG. API and UI are also to be available to discover or update the type information. When the type of a base class property has restrictions defined, these restrictions are inherited to all child classes of that base class. Further, a model upgrade method is added to enable the addition of type information to already existing schemas, avoiding the need to reload the entire model.

The values constraints are to be added as a new schema element, EntityCharacteristicType (step 312) in the schema in the graph database (185). The element can be standalone when loaded as a type definition and can be associated with an EntityCharacteristicSpec, when that specification uses the type. The EntityCharacteristicSpec does not link a type object in simple cases and continues to record the name of the type in the valueType field.

However, when an extended type is to be used, the EntityCharacteristicSpec links the EntityCharacteristicType object. At the same time, the EntityCharacteristicSpec records the name of the extended type in the valueType. field. The EntityCharacteristicType defines new types, by augmenting a base (scalar) type as provided in table. 1.

TABLE 1

| | | Manda- | | | |
|---|---|---|---|---|---|
| Field | Type | tory | Default | Unique | Meaning |
| name | String | N | Generated | Y | Assigned name of |
| | | | | | value spec, |
| ectShared | Int | Y | False | N | Whether value spec is |
| | | | | | shared or dedicated to |
| | | | | | a particular |
| | | | | | characteristic. Non- |
| | | | | | shared types are either |
| | | | | | in-line or module- |
| | | | | | level types, and can |
| | | | | | only be used by the |
| | | | | | specific classes that |
| | | | | | define the type, or |
| | | | | | properties in the same |
| | | | | | module that defined |
| | | | | | the type. Shared types |
| | | | | | are externally loaded, |
| | | | | | and can be used by |
| | | | | | any class. |
| ectType | String | Y | None | N | The type that is being |
| | | | | | extended: |
| | | | | | string type can be |
| | | | | | extended with |
| | | | | | length, pattern |
| | | | | | int32, int64 can |
| | | | | | be extended with |
| | | | | | range |
| | | | | | enumeration is |
| | | | | | its own basic type |
| | | | | | (effectively a |
| | | | | | string). |
| ectRange | Long | N | None | N | lo . . . hi range, applied |
| | | | | | to numeric types |
| ectEnum | LIST | N | None | N | A list of valid enum |
| | | | | | values. [“red”, “blue”], |
| | | | | | applied to string |
| | | | | | types |
| ectLength | String | N | None | N | Either a single max |
| | | | | | length value, or range |
| | | | | | min . . . max of allowed |
| | | | | | length. Applied to |
| | | | | | string types. |
| ectPattern | String | N | None | N | Regex pattern to be |
| | | | | | applied, applied to |
| | | | | | string types |

A YANG model for addition of the value constraints as the new scheme element is provided. The value types map directly from YANG type definitions. There are three main scoping options to using the value types which includes using the value types at local level, at a module level and at global level.

At the local level, the value types are defined at the place where the value types are used and affect only that property. The value types is not available for other properties. In an example, consider a definition of enumeration values for the domain property only. If another property needs the same values the same definition cannot be reused, except by duplication as illustrated below.

```
module XXX {
....
container attributes {
  description “SomeClass properties”;
  leaf domain {
    type enumeration {
        enum RAN;
        enum CORE;
        enum OTHER;
    }
    mandatory “false”;
    description “”;
    default “”;
  }
      leaf direction {
    type enumeration {
        enum LEFT;
        enum RIGHT;
        enum OTHER;
    }
  }
  }
  ...
```

At the module level, the value types are defined using YANG typedef mechanism which is then referenced in multiple locations in the module. For example, the below code defines two properties, domain and parentDomain, both using the enumeration definition.

```
module ZZZ {
typedef domainEum {
  type enumeration {
    enum RAN;
    enum CORE;
    enum OTHER;
  }
}
....
container attributes {
    description “SomeClass properties”;
    leaf domain {
      type domainEnum {
      mandatory “false”;
      description “”;
      default “”;
    }
    leaf parentDomain {
      type domainEnum {
      mandatory “false”;
      description “”;
      default “”;
    }
    }
```

At the global level, the value types are defined at a global level in a separate file, and installed as globally available definitions. There may be multiple types defined in a single file. Once loaded, these type definitions can be used in any other class.

```
module domainType{
    namespace “http://rakuten.com/RCP/network”;
      organization “”;
    description “”;
      revision 2019-10-20 {
      description “Initial version.”;
    }
        typedef domainType {
      type enumeration {
        enum CORE;
        enum RAN;
        enum OTHER;
      }
    }
          typedef domainType {
      type enumeration {
        enum CORE;
        enum RAN;
        enum OTHER;
      }
    }
    typedef otherType {
      ...
    }
  }
```

Loading the file which defines the value types globally is available in any other YANG in the graph database (185). Subsequent YANG definitions can make use of the value type as:

```
module XXX {
import domainType { prefix t; }
....
container attributes {
  description “SomeClass properties”;
  leaf domain {
    type t.domainType {
    mandatory “false”;
    description “”;
    default “”;
  }
  leaf parentDomain {
    type t.domainType {
    mandatory “false”;
    description “”;
    default “”;
  }
  }
```

Further, multiple files defining the value types may be loaded, each may contain one or more type definitions. The types are not versioned. Any updates to the global types are generally restricted to only those shared types that have no references. The one exception is that enumerations can be extended, even if they have references. The entity specifications can include type specifications in the YANG of the module. These are loaded as part of the module, and become private types for those modules. Technically, a typedef in any YANG can be imported in another YANG with further development.

Various examples of the value specifications loaded from the YANG models which are extended for various value constraints as follows:

### Enumerations Example 1

```
container attributes {
  description “SomeClass properties”;
  leaf propName {
    type enumeration {
      enum value1;
      enum value2
    }
    mandatory “false”;
    description “”;
    default “”;
  }
  }
```

Therefore, in the above example 1, the user cannot provide any other value string for the property except for value1 and value2. In case the user provides any other value, then the value constraint management server (100) will display an error message to the user and does not allow the creation of the entity.

In another embodiment, the enums can be loaded independently, and then referred from leaf declarations, as follows:

```
typedef sharedEnumeration {
  type enumeration {
    enum RAN;
    enum CORE;
    enum OTHER;
  }
}
```

And usage is:

leaf domain {
type sharedEnumeration;
}

### Ranges:

An in-place range definition for an int32 that can take values 1, 2, 3, 4:

```
module CNF {
container attributes {
leaf name {
  type string;
}
leaf rangedValue {
  type int32 {
    range “1..4”;
  }
  description “”;
  default “”;
  ...
}
```

An example of a range defined at module, or global level for an number that can take values between and including 1 and 9999:

```
typedef rangedInt {
  type int32 {
    range “1..9999”
  }
}
```

To use the above definition as:

leaf usesRange {
type rangedInt;
}

### Length:

In an example, consider an in-place usage of the length constraint, defining a string that must be at least 1 character, but at most 4 characters long as indicated below:

```
leaf rangedValue {
  type string {
    length “1..4”;
  }
}
```

A reusable pattern for a string that has max 100 characters with no minimum length value is provided as below:

```
typedef string100 {
  type string {
    length “100”;
  }
}
```

### Pattern:

An example of a shared definition of a string that must start with an uppercase letter and may contain numbers and digits after. Regular expressions are not anchored by default, i.e. \hat{ } and $ should be used to explicitly indicate start and end of value.

```
typedef capitalised {
  type string {
    pattern “\hat{ }[A-Z][a-z0-9]*$”;
  }
}
```

Here, the proposed method operates at the validation layer of the graph database (185) and hence allows creation of the entity only when the values of the properties of the entities are validated. As a result, the proposed method reduces efforts of users to manually check and validate individual entities after the entities are created.

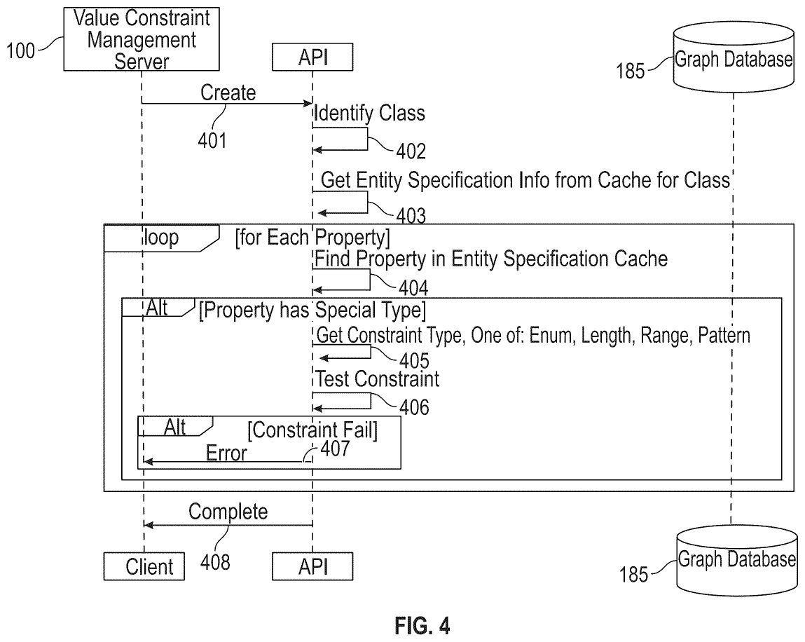

FIG. 4 illustrates a step-by-step process for application of type validation during validation phase of the entity creation, according to an embodiment as disclosed herein.

At step 401, a create API is provided by the value constraint management server (100) to an API interface and at step 402, the API interface identifies a class of the create API command. The type validation with the value constraints is applied during input object validation.

At step 403, the API interface determines and fetches EntitySpecification info from cache of the value constraint management server (100) for the identified class of the create API. The type validation loads the EntitySpecification objects from which to validate the data. With augmented types, the additional type information is also loaded with the EntitySpecification, and used to apply additional rules. As an optimisation, the EntitySpecification data is to be cached in memory to avoid database interactions during object validation. Part of the cache is to include the type information, keyed on the name of the type, to be also readily locatable from the EntityCharacteriticSpec. This may be through a hashmap of typename to EntityCharacteriticType objects.

Further, for each property of the entity to be created, the property is determined from the EntitySpecification provided in the YANG file (step 404) and the value constrained is applied to check if the property values is in consonance with the value constraints (step 404 and step 405). If the property values are not in consonance with the value constraints, then the value constraint management server (100) provides the error message to the user (step 407) and the entity is not created (step 408). If the property values are in consonance with the value constraints, then the entity with the determined properties along with the property values is created and the process is completed.

The value constraints based validation applies to two main cases in the graph database (185) i.e., object creation (single, composite and bulk) and object update (single, bulk).

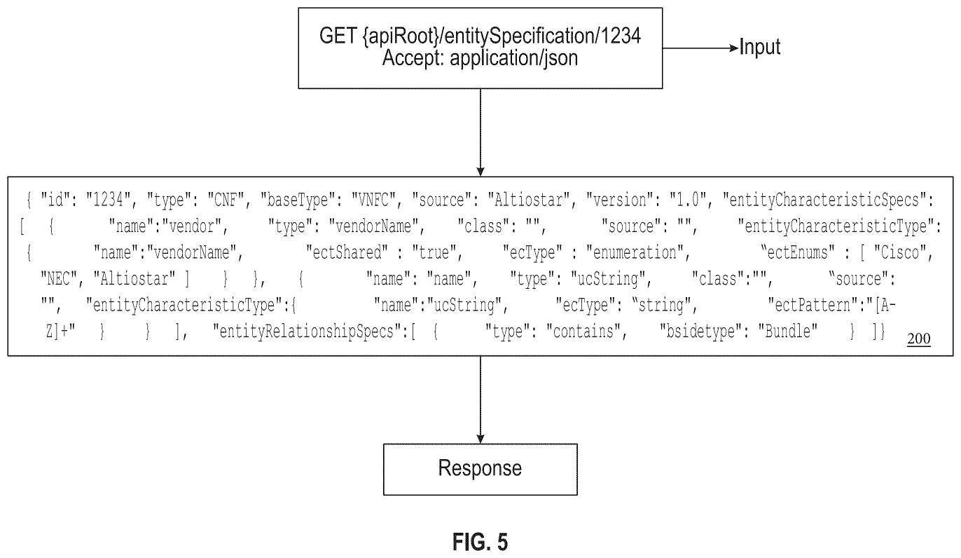

FIG. 5 is an example illustrating response for a GET API, according to an embodiment as disclosed herein.

CRUD API for EntityCharacteristicType: Create, Run, Update and Delete specific API for the EntityCharacteristicType is provided below:
1. Create EntityCharacteristicType:
API—POST {apiRoot}/entityCharacteristicType
Description: Create an EntityCharacteristicType. The inputs are provided in table. 2:

TABLE 2

| | | Manda- | | |
|---|---|---|---|---|
| Field | Type | tory | Default | Meaning |
| name | String | Y | Generated | Assigned name of value |
| | | | | spec. This must be unique. |
| ectShared | Int | Y | False | Whether value spec is shared |
| | | | | or dedicated to a particular |
| | | | | characteristic. Non-shared |
| | | | | types are either in-line or |
| | | | | module-level types, and can |
| | | | | only be used by the specific |
| | | | | classes that define the type, |
| | | | | or properties in the same |
| | | | | module that defined the |
| | | | | type. Shared types are |
| | | | | externally loaded, and can |
| | | | | be used by any class. |
| ectType | String | Y | None | The type that is being |
| | | | | extended: |
| | | | | string type can be |
| | | | | extended with length, |
| | | | | pattern |
| | | | | int32, int64 can be |
| | | | | extended with range |
| | | | | enumeration is its own |
| | | | | basic type (effectively a |
| | | | | string). |
| ectRange | Long | exactly | None | lo . . . hi range, applied to |
| | | one | | numeric types |
| | | must | | |
| | | be set | | |
| ectEnum | LIST | | None | A list of valid enum values. |
| | | | | [“red”, “blue”], applied to |
| | | | | string types |
| ectLength | String | | None | Either a single max length |
| | | | | value, or range min . . . max |
| | | | | of allowed length. Applied |
| | | | | to string types. |
| ectPattern | String | | None | Regex pattern to be applied, |
| | | | | applied to string types |

According to the proposed method, only one of the ectRange, the ectEnum, the ectLength, the ectPattern can be set. The field to be set is determined by ectType as provide in table. 3:

TABLE 3

| ectType | ectRange | ectEnum | ectLength | ectPattern |
|---|---|---|---|---|
| int32, int64 | [symbol] | | | |
| enumeration | | [symbol] | | |
| string | | | [symbol] | [symbol] |

When called from an external API, ectShared must be true. Shared types can only create internally.

### Input:

```
{
  “entityCharacteristicType”: {
    “name”: “vendorName”,
    “ectShared”: “true”,
    “ecType”: “enumeration”,
    “ectEnums”: [
      “Cisco”,
      “NEC”,
      “Altiostar”
    ]
  }
}
```

### Response:

200 OK
{
}
400
{
“code” : “Invalid Range”
}

Errors (table. 4):

TABLE 4

| Error | Meaning |
|---|---|
| | Name already exists |
| | Invalid input, see error code |

2. GET EntityCharacteristicType:
API—GET {apiRoot}/entityCharacteristicType/{name}
Description: Retrieve a type by its unique name.

### Response:

```
{
  “entityCharacteristicType”: {
    “id” : “33232323”,
    “name”: “vendorName”,
    “ectShared”: “true”,
    “ecType”: “enumeration”,
    “ectEnums”: [
      “Cisco”,
      “NEC”,
      “Altiostar”
    ]
  }
}
```

Errors (table. 5):

TABLE 5

| Error | Meaning |
|---|---|
| 404-Not found | Type not defined for name |

3. LIST EntityCharacteristicType:
API—GET {apiRoot}/entityCharacteristicType?shared=true|false|all
Description: Return all defined types.

### Response:

```
[
  {
    “entityCharacteristicType”: {
      “id”: “535199e0-8b18-4950-b378-4645dae400c3”,
      “name”: “vendorName”,
      “ectShared”: “true”,
      “ecType”: “enumeration”,
      “ectEnums”: [
        “Cisco”,
        “NEC”,
        “Altiostar”
      ]
    }
  },
  {
    “entityCharacteristicType”: {
      “id”: “535199e0-8b18-4950-b378-4645dae400c3”,
      “name”: “domainName”,
      “ectShared”: “true”,
      “ecType”: “enumeration”,
      “ectEnums”: [
        “RAN”,
        “TRANS”,
        “CORE”
      ]
    }
  }
]
```

4. UPDATE EntityCharacteristicType
API—PATCH {apiRoot}/entityCharacteristicType

Description: Update parts of a type. There are restrictions on updating types as follows. If a type is used (determined by [symbol] _ [symbol] _ [symbol] edges) then only enumeration types can be changed, and then only by the addition of values to ectEnums.

If a type is not used, then only the following fields can be changed:
ectEnums
ectLength
ectRange
ectPattern

These can only be set in a way that is compatible with the setting of ectType. e.g. if ectType==enumeration, then only ectEnums can be set. ectEnums has special handling. Being an array, the patch payload allows the caller to specify which items are to be added, or removed.

### Input:

```
{
  “entityCharacteristicType”: {
    “name”: “vendorName”,
    “ectShared”: “true”,
    “ecType”: “enumeration”,
    “ectLength” : “new value”,
    “ectEnums”: {
      “add” : [
        “Cisco”,
        “NEC”,
        “Altiostar”,
        “Huawei”
      ],
      “remove” : [ ],
      “replace” : [ ]
    ]
  }
}
```

5. DELETE Create EntityCharacteristicType
API—DELETE {apiRoot}/entityCharacteristicType/{name}

Description: Delete a type, but only if not used.

### Result

200 OK
{
}

6. Updates to EntitySpecification API
GET Specification
API—GET {apiRoot}/entitySpecification/{id}?include=types

Description: Get an entity specification, and attached characteristic and relationship specifications for a particular spec.

### Attributes (Table. 6):

TABLE 6

| Attribute | Type | |
|---|---|---|
| id | string, | ID of entity |
| | mandatory | |
| include | string, | types-to include details of the type. |
| | optional | If not specified, the type |
| | | information is not shown. |

### Returns (Table. 7):

TABLE 7

| Code | Message | Condition |
|---|---|---|
| 200 | OK | Returns Object |
| 404 | Not found | Object by ID does not exist |

Referring to the FIG. 5, consider the example, where the GET EntityCharacteristicType for 1234 is received and the corresponding response is populated. The response is determined by retrieving the type by the unique name (1234) where the API is:
GET {apiRoot}/entitySpecification/{1234}

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method for managing value constraints associated with properties of entities in a graph database, wherein the method comprises:
receiving, by a value constraint management server, a request for creation of at least one entity, wherein the request comprises values associated with a plurality of properties of the at least one entity to be created;
generating, by the value constraint management server, an entity configuration file based on the values associated with the plurality of properties of the at least one entity to be created, wherein the entity configuration file comprises at least one value constraint from a plurality of value constraints to be applied to the at least one entity;
retrieving, by the value constraint management server, metadata corresponding to value constraints from a constraint database; based on the entity configuration file;
creating, by the value constraint management server, the at least one entity based on the metadata corresponding to the value constraints and the values associated with the plurality of properties of the at least one entity to be created; and
storing, by the value constraint management server, the at least one entity in the graph database.

2. The method as claimed in claim 1, wherein creating, by the value constraint management server, the at least one entity based on the metadata corresponding to the value constraints and the information of the at least one entity comprises:
determining, by the value constraint management server, whether the values associated with the plurality of properties of the at least one entity to be created matches the value constraints in the entity configuration file; and
performing, by the value constraint management server, one of:
creating the at least one entity based on the metadata corresponding to the value constraints and the information of the at least one entity, in response to determining that the values associated with the plurality of properties of the at least one entity to be created matches the value constraints in the entity configuration file, and
displaying an error message indicating that the at least one entity cannot be created based on the received request, in response to determining that the values associated with the plurality of properties of the at least one entity to be created does not match the value constraints in the entity configuration file.

3. The method as claimed in claim 1, wherein the value constraint management server operates in a validation layer of the graph database.

4. The method as claimed in claim 1, wherein the at least one value constraint comprises at least one of: at least one of enumerations of a property of the at least one entity, a range of a property of the at least one entity, a length of a property of the at least one entity and a pattern of a property of the at least one entity.

5. The method as claimed in claim 1, further comprises:
receiving, by the value constraint management server, a request to update a portion of a value associated with at least one property of the plurality of properties of the at least one entity;
determining, by the value constraint management server, whether a value type for the at least one property is available in the graph database;
performing, by the value constraint management server, one of:
updating of only enumeration of the at least one property, in response to determining that the value type for the at least one property is available in the graph database, and
updating at least one of the enumerations of the property of the at least one entity, the range of the property of the at least one entity, the length of the property of the at least one entity and the pattern of the property of the at least one entity, in response to determining that the value type for the at least one property is not available in the graph database.

6. A value constraint management server for managing value constraints associated with properties of entities in a graph database, wherein the value constraint management server; comprises:
a memory;
a processor coupled to the memory;
a communicator coupled to the memory and the processor;
a value management controller; coupled to the memory, the processor and the communicator, and wherein the value management controller is configured to:
receive a request for creation of at least one entity, wherein the request comprises values associated with a plurality of properties of the at least one entity to be created;
generate an entity configuration file based on the values associated with the plurality of properties of the at least one entity to be created, wherein the entity configuration file comprises at least one value constraint from a plurality of value constraints to be applied to the at least one entity;
retrieve metadata corresponding to value constraints from a constraint database based on the entity configuration file;
create the at least one entity based on the metadata corresponding to the value constraints and the values associated with the plurality of properties of the at least one entity to be created; and
store the at least one entity in the graph database.

7. The value constraint management server as claimed in claim 6, wherein the value management controller is configured to create the at least one entity based on the metadata corresponding to the value constraints and the information of the at least one entity comprises:
determine whether the values associated with the plurality of properties of the at least one entity to be created matches the value constraints in the entity configuration file; and
perform one of:
create the at least one entity based on the metadata corresponding to the value constraints and the information of the at least one entity, in response to determining that the values associated with the plurality of properties of the at least one entity to be created matches the value constraints in the entity configuration file, and
display an error message indicating that the at least one entity cannot be created based on the received request, in response to determining that the values associated with the plurality of properties of the at least one entity to be created does not match the value constraints in the entity configuration file.

8. The value constraint management server as claimed in claim 6, wherein the value constraint management server operates in a validation layer of the graph database.

9. The value constraint management server as claimed in claim 6, wherein the at least one value constraint comprises at least one of: at least one of enumerations of a property of the at least one entity, a range of a property of the at least one entity, a length of a property of the at least one entity and a pattern of a property of the at least one entity.

10. The value constraint management server as claimed in claim 6, wherein the value management controller is further configured to:
receive a request to update a portion of a value associated with at least one property of the plurality of properties of the at least one entity;
determine whether a value type for the at least one property is available in the graph database;
perform one of:
update of only enumeration of the at least one property, in response to determining that the value type for the at least one property is available in the graph database, and
update at least one of the enumerations of the property of the at least one entity, the range of the property of the at least one entity, the length of the property of the at least one entity and the pattern of the property of the at least one entity, in response to determining that the value type for the at least one property is not available in the graph database.

11. A computer program product for managing value constraints associated with properties of entities in a graph database, wherein the CPP comprises:
a computer executable program code recorded on a computer readable non-transitory storage medium, wherein said computer executable program code when executed causing the actions including:
receiving a request for creation of at least one entity, wherein the request comprises values associated with a plurality of properties of the at least one entity to be created;
generating an entity configuration file based on the values associated with the plurality of properties of the at least one entity to be created, wherein the entity configuration file comprises at least one value constraint from a plurality of value constraints to be applied to the at least one entity;
retrieving metadata corresponding to value constraints from a constraint database based on the entity configuration file;
creating the at least one entity based on the metadata corresponding to the value constraints and the values associated with the plurality of properties of the at least one entity to be created; and
storing the at least one entity in the graph database.

12. The CPP as claimed in claim 11, wherein creating the at least one entity based on the metadata corresponding to the value constraints and the information of the at least one entity comprises:
determining whether the values associated with the plurality of properties of the at least one entity to be created matches the value constraints in the entity configuration file; and
performing one of:
create the at least one entity based on the metadata corresponding to the value constraints and the information of the at least one entity, in response to determining that the values associated with the plurality of properties of the at least one entity to be created matches the value constraints in the entity configuration file, and
display an error message indicating that the at least one entity cannot be created based on the received request, in response to determining that the values associated with the plurality of properties of the at least one entity to be created does not match the value constraints in the entity configuration file.

13. The CPP as claimed in claim 11, wherein the value constraint management server operates in a validation layer of the graph database.

14. The CPP as claimed in claim 11, wherein the at least one value constraint comprises at least one of: at least one of enumerations of a property of the at least one entity, a range of a property of the at least one entity, a length of a property of the at least one entity and a pattern of a property of the at least one entity.

15. The CPP as claimed in claim 11, further comprises:
receiving a request to update a portion of a value associated with at least one property of the plurality of properties of the at least one entity;
determining whether a value type for the at least one property is available in the graph database;
performing one of:
update of only enumeration of the at least one property, in response to determining that the value type for the at least one property is available in the graph database, and
update at least one of the enumerations of the property of the at least one entity, the range of the property of the at least one entity, the length of the property of the at least one entity and the pattern of the property of the at least one entity, in response to determining that the value type for the at least one property is not available in the graph database.
